(19) United States
(12) Patent Application Publication
(10) Pub. No.: US 2018/0050508 A1
(43) Pub. Date: Feb. 22, 2018

(54) METHODS FOR FORMING PARTIAL RETROREFLECTOR TOOLING AND SHEETING AND DEVICES

(71) Applicant: ORAFOL AMERICAS INC., Avon, CT (US)

(72) Inventors: Frank KUEHNLENZ, Jena (DE); Christian KASPER, Eckartsgerga (DE); Steven SCOTT, Avon, CT (US)

(21) Appl. No.: 15/556,843

(22) PCT Filed: Mar. 9, 2015
(86) PCT No.: PCT/US15/19394

§ 371 Date: Sep. 8, 2017

(51) Int. Cl. B29D 11/00; G02B 5/124

(52) U.S. Cl. CPC B29D 11/00605; G02B 5/124

(57) ABSTRACT

A method of forming a partial retroreflector tool includes forming a substrate comprising a retroreflective microstructure pattern on a surface thereof. The surface of the substrate is machined to remove at least a portion of the retroreflective microstructure pattern to form a partial retroreflective microstructure pattern on the surface of the substrate to generate the partial retroreflector tool. A method of fabricating a partially retroreflective sheeting utilizing the partial retroreflector tool is also disclosed.

### FIELD

This technology generally relates to methods and devices for retroreflector tooling and retroreflective sheeting, and more particularly to methods for forming partial retroreflector tooling and partial retroreflective sheeting and devices thereof.

### BACKGROUND

Retroreflective films and sheeting may be utilized in various applications to redirect light incident on the retroreflective prisms located in the sheeting through total internal reflection (TIR). TIR occurs where the prisms are located on the back of the film or sheeting and the light rays travel through the sheeting and reflect off the surface of the prisms due to the polymer to air interface of the prisms. Altering the geometry of the prisms can impact the retroreflective qualities. Specifically, there are increasing applications for partially retroreflective films and sheeting that allow for partial transmission and partial reflection of incident light. In particular, partial retroreflective sheeting may be utilized in display applications.

Traditionally, retroreflective microstructures are fabricated using machining methods to create a master tool. Machining retroreflective microstructures often involves the use of a single-point diamond tooling to machine the microstructures onto a suitable blank substrate (see, e.g., U.S. Pat. No. 6,253,442). Flycutting or ruling is typically used to machine the substrate in order to achieve the levels of precision required for retroreflective sheeting specifications (see, e.g., U.S. Pat. No. 5,156,863). During the flycutting process, a high-speed spindle rotates the single-point diamond tool about an axis as the tool traverses along the linear axis of the machine tool. Using this method, cuts are made in the substrate from one side of the substrate to the other at a spacing based on the desired final geometry of the retroreflector.

After the master has been formed, it can be replicated by electroforming and replicating the master many times into opposite generation electroforms. The multiple electroforms may be tiled or parqueted together to create a finished tool of a large enough size to enable the production of retroreflective sheeting or film. Altering the geometry of the master tool to provide partial retroreflective sheeting changes the retroreflective properties of the final product.

### SUMMARY

A method of forming a partial retroreflector tool includes forming a substrate comprising a retroreflective microstructure pattern on a surface thereof. The surface of the substrate is machined to remove at least a portion of the retroreflective microstructure pattern to form a partial retroreflective microstructure pattern on the surface of the substrate to form the partial retroreflector tool.

A method for fabricating partially retroreflective sheeting includes obtaining a partial reflector tool having a substrate with a surface with a machined partial retroreflective microstructure pattern. A polymer material is introduced on the machined partial retroreflective microstructure pattern on the surface of the partial reflector tool. The introduced polymer material is separated from the surface of the partial retroreflector tool to generate the partially retroreflective sheeting.

With this technology, a partial retroreflector tool is formed by machining the surface of a substrate having a retroreflective microstructure pattern thereon to remove a portion of the substrate. Removal of the portion of the substrate forms a partial retroreflective microstructure pattern on the substrate. The process advantageously allows for machining an easily alterable polymer, or other single point diamond machinable surface, to form a tool having the partial retroreflective microstructure pattern on a surface. Additionally, the process provides flexibility in the amount of retroreflectivity imparted by the resultant part. Further, the tool may be advantageously replicated to form large, partially retroreflective sheeting that may be utilized in display applications. One such application is the ability to have an image retroreflected back to a viewer while enabling the viewer to see through the sheeting, such as in a window. Thus, an image can be formed as in a heads-up display using the partial retroreflective sheeting.

### BRIEF DESCRIPTION OF THE DRAWINGS

FIG. 1 is a side view of an example of a partial retroreflector tool;

FIG. 2 is a flow chart of an example of a method of producing a partial retroreflector tool;

FIG. 3 is a side view of an example of a substrate having a retroreflective microstructure pattern formed on a surface during the example of the method illustrated in FIG. 2; and

FIG. 4 illustrates the example of the substrate shown in FIG. 3 after machining to remove at least a portion of the retroreflective microstructure pattern to form a partial retroreflective microstructure pattern on the surface of the substrate formed by the method illustrated in FIG. 2.

FIG. 5 is a top view of the substrate illustrated in FIG. 4.

FIG. 6 is a flow chart of an example of a method of fabricating a partially retroreflective sheeting.

FIG. 7 is an illustration of an application of the partially retroreflective sheeting fabricated by the method illustrated in FIG. 2.

### DETAILED DESCRIPTION

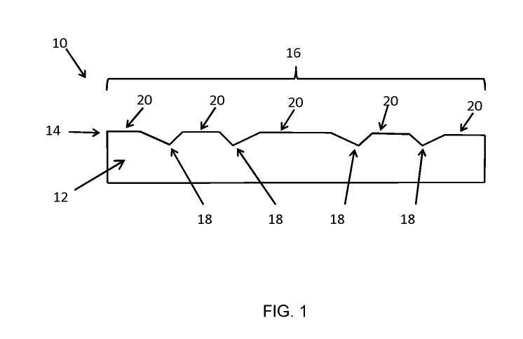

An example of a method of forming a partial retroreflector tool and partially retroreflective sheeting containing partially retroreflective microstructure patterns is illustrated and described with reference to FIGS. 1-7. The partial retroreflector tool 10 includes a substrate 12 with a surface 14 containing a partial retroreflector microstructure pattern 16 thereon, although the partial retroreflector tool 10 can comprise other types and/or numbers of other components or other elements. The present technology provides more efficient methods of creating the partial retroreflector tool and partially retroreflective sheeting. Further, the amount of retroreflectivity may be easily varied. Replication of the tool allows for the generation of large area, partially retroreflective sheeting, which is utilized in a number of applications in which partial retroreflection is desired.

Referring more specifically to FIG. 1, the partial retroreflector tool 10 includes the substrate 12, which may be a nickel substrate, although other suitable metals or other materials, such as a polymer, may be utilized for the substrate 10. The substrate 12 includes a surface 14 containing the partial retroreflective microstructure pattern 16. The partial retroreflective microstructure pattern 16 includes retroreflector structures 18 and a non-retroreflective surface 20. The retroreflector structures 18 and a non-retroreflective surface 20 are described in detail below with respect to the method of fabricating a partial retroreflector tool. The combination of the retroreflector surfaces 18 and a non-retroreflective surface 20 allows for the partial retroreflector tool 10 to be utilized to generate partially retroreflective sheeting as described below.

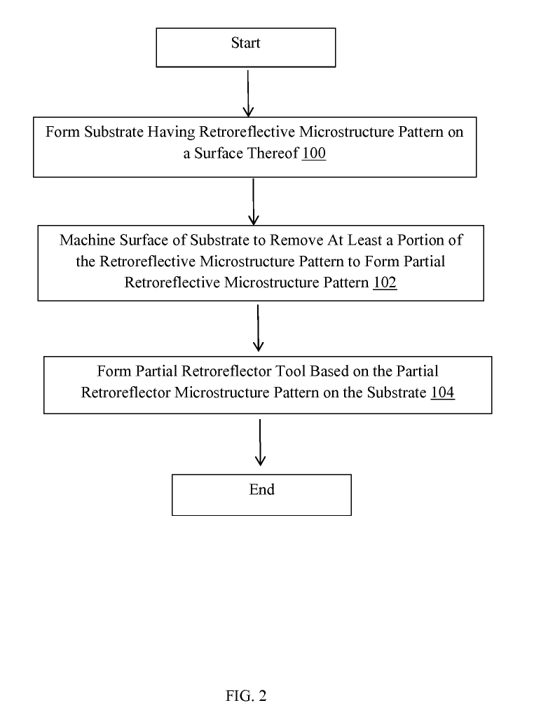

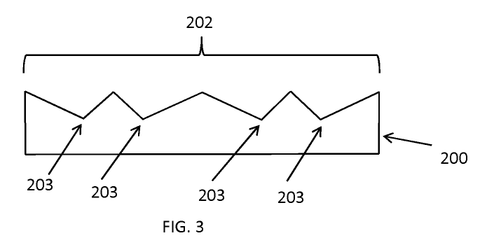

Referring now to FIG. 2, a method of fabricating a partial retroreflector tool will be described. In step 100 a substrate 200 is formed having a retroreflective microstructure pattern 202 on a surface thereof as illustrated by the example shown in FIG. 3. The substrate 200 is formed based on an electroform having an odd generation of the retroreflective microstructure pattern 202, such as an odd generation nickel electroform, although other types and/or numbers of materials may be utilized. The substrate 200 is formed with the microstructured retroreflective pattern 202 as an odd generation of the retroreflective microstructure pattern located on the surface. The substrate 200 is a replica of a master. The master is an even generation tool with the prisms protruding from the surface. The substrate 200 is an odd generation replica. Odd generation tooling is tooling or parts made from the even generation master as explained in further detail below.

In one example, the substrate 200 is formed using compression molding techniques, such as described in U.S. Pat. No. 5,204,127, which is hereby incorporated by reference in its entirety, although other methods of forming the retroreflective microstructure pattern 202 on the substrate 200 may be utilized. The substrate 200 may be constructed of a polymer, by way of example, although other types and/or numbers of other suitable materials such as polymeric epoxies, acrylics, polyester, polyurethane, polycarbonate, or other similar materials or curable resins could be used. A copper electroform or high phosphorous nickel electroform can also be used to achieve a diamond machinable substrate.

The retroreflective microstructure pattern 202 comprises a number of retroreflector structures 203. By way of example, the retroreflective microstructure pattern 202 may include retroreflector structures 203 such as triangular, hexagonal, pentagonal, or rectangular projected aperture retroreflectors, although other variations in retroreflective microstructure pattern 202 may be employed in the methods described herein. The design variations may be applied to individual retroreflector structures 203 within the retroreflective microstructure pattern 202, to groups of retroreflectors, or a combination of both.

The retroreflective microstructure pattern 202 may further include multiple types of retroreflector structures 203 (i.e., multiple prism variations) formed in the substrate 200. The prism variations can include individual prisms with variations in tilt, size, cant, and rotation, although other variations in the prisms can be used. Prism variations may be applied to individual prisms within the retroreflective microstructure pattern 202 or to groups of prisms, or to a combination of both. By varying the design and prism variations utilized and transferred to the substrate 200, the photometric performance of the end product, e.g., a partially retroreflective sheeting, can be specifically tailored. The size of the retroreflector structures 203 and spacing between individual retroreflector structures 203 in the retroreflective microstructure pattern 202 may also be varied, by way of example. In one example, the retroreflective microstructure pattern 202 may include a random array of microstructures that may be utilized to form a master having the random array of microstructures thereon.

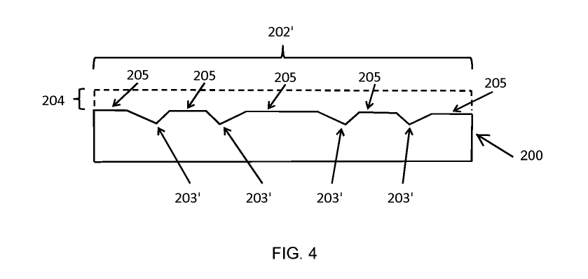

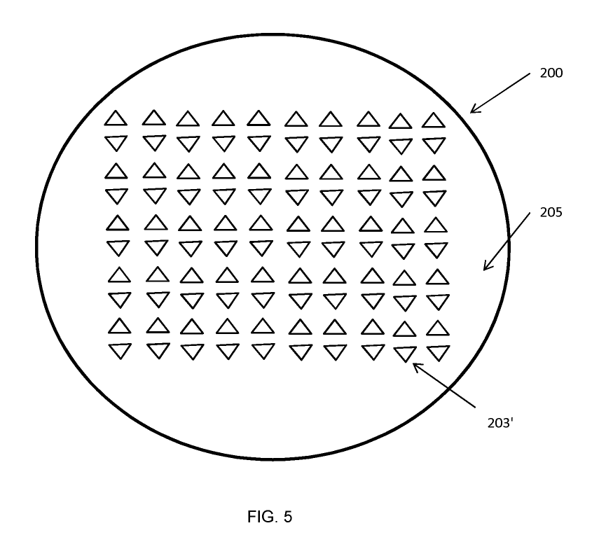

Next, in step 102, a portion 204 of the surface of the substrate 200 is machined away to form a partial retroreflective microstructure pattern 202′ on the surface of the substrate 200 including retroreflector structures 203′ as illustrated by way of example in FIGS. 4 and 5. In one example, the portion 204 of the surface removed from the substrate is a uniform layer of approximately 80 μm in depth, although other portions in other distributions may be removed from the surface of the substrate 200. In this example, the surface of the substrate 200 is machined using a single-point diamond cutting tool to remove material from the surface of the substrate 200, although other methods of machining the substrate 200 to form the partial retroreflective microstructure pattern 202′ may be utilized. A polymer substrate may be utilized, by way of example, to facilitate the machining of substrate 200, although other suitable materials may also be utilized. The surface roughness of the remaining substrate surface 205 is maintained at a low surface roughness comparable to a polished surface. This allows the surface to be replicated into partial retroreflective sheeting and be highly transparent so that it can perform as a window while still retaining some partial retroreflective properties.

In one example, the surface of the substrate 200 is machined in a direction parallel to the surface. The machining creates a polished area 205 on the surface of the substrate located between the retroreflector structures 203 as illustrated in FIGS. 4 and 5. With part of the retroreflective prisms removed, the polished area 205 no longer provides complete retroreflection of incident light beams, resulting in the partial retroreflective microstructure pattern 202′ on the surface of the substrate 200. Specifically, the overall surface area of the retroreflector structures 203′ (i.e., prisms), which form the retroreflective surface area in the partial retroreflective microstructure pattern 202′ is less than the surface area of the retroreflector structures 203 of retroreflective microstructure pattern 202 as illustrated in FIG. 3. The decrease in retroreflective surface area contributes to a decrease in the overall retroreflectivity of a corresponding part including the partial retroreflective pattern 202′, such as a partially retroreflective sheeting for a display application.

In one example, the retroreflective microstructure pattern 202 may be machined to remove up to 95% of the retroreflective surface area on the substrate 200, although the machining may be varied to provide any other percentages of retroreflective surface area in the partial retroreflective microstructure pattern 202′ on the polymer substrate. For example, the machining may remove approximately 5% to 95% of the retroreflective surface area provided by the original retroreflective microstructure pattern 202. The retroreflective surface area is varied based on the size and shape of the retroreflector structures 203 in the original retroreflective microstructure pattern 202 and the desired ratio of transparent area to retroreflective area of the end product.

In another example, the amount of machining away from the surface may be varied at different areas of the retroreflective microstructure pattern 202 to vary the amount of retroreflective prism area across the substrate 200 in partial retroreflective microstructure pattern 202′. By way of the example, a substrate may be machined with 10% of the retroreflective surface area containing retroreflective microstructures remaining at a top portion of the substrate, with the amount of retroreflective surface area remaining moving gradually to 40% toward the bottom portion of the substrate, although other variations, including left to right variations, circular or radial variations, or random variations in the amount of retroreflective surface area may be formed by the machining of the surface of the substrate 200.

In step 104, the partial reflector tool is formed based on the partial retroreflector microstructure pattern 202′ on the substrate 200 as illustrated by way of example in FIG. 4. The partial retroreflective microstructure pattern 202′ formed on the substrate 200 is transferred into a partial retroreflector tool that includes the partial retroreflective microstructure pattern 202′ on a surface thereof, although the substrate 200 may be utilized as an odd generation stamper itself to form partial retroreflective sheeting.

In one example, the substrate 200 is electroformed to create the partial retroreflector tool. If the substrate 200 is not metal and thus not conductive, in order to electroform from the substrate 200, a silver spray process is used to create a thin conductive coating on the surface of the substrate 200 containing the partial retroreflective microstructure pattern 202′, although any other methods for creating a conductive surface coating for electroforming, such as vacuum metalizing, can be used. The substrate 200 containing the thin conductive coating is then deposited in an aqueous nickel sulfamate bath to electrodeposit a metal layer on the areas of the substrate 200 coated with conductive material. A nickel bath can be used to create a nickel replica of the surface of the substrate 200 containing the partial retroreflective microstructure pattern 202′, although other suitable materials, such as copper by way of example only, may be utilized. The electroformed partial retroreflector tooling contains a positive or even generation copy of the partial retroreflective microstructure pattern 202′ on a surface thereof. The mold is then removed. The electroform process may then be repeated on the generated electroform to obtain the proper generation for use as a partial retroreflector tool. The generated partial retroreflector tool may be used in a casting, embossing, or other polymer forming process. Odd generation tooling is used to make polymer sheeting or film that is capable of retroreflection due to TIR when the light enters the sheeting and is retroreflected from the prisms on the rear of the sheeting.

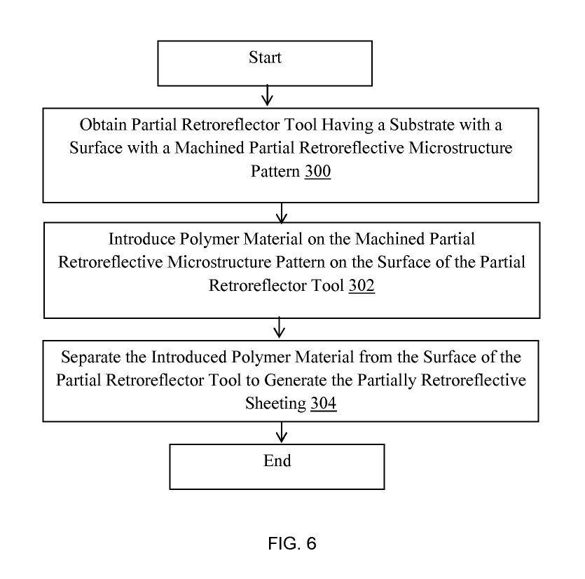

Referring now to FIGS. 1 and 6, a method of fabricating a partial retroreflective sheeting will be described. In step 300, a partial retroreflector tool, such as partial retroreflector tool 10 illustrated in FIG. 1, is obtained. The partial retroreflector tool 10 may be utilized to form a partial retroreflective sheeting. The partial retroreflective sheeting contains a copy of the partial retroreflective microstructure pattern 16 on a surface thereof to provide partial retroreflection of incident light. In another example, the partial retroreflector tool 10 may be replicated a number of times to form a plurality of partial retroreflector tools having the same partial retroreflective microstructure pattern 16. The plurality of partial retroreflector tools can be parqueted together to form large area tooling for the manufacture of large area sheeting using the methods described below.

Next, in step 302, a polymer material is introduced on the machined partial retroreflective microstructure pattern 16 on the surface of the partial reflector tool 10. The partial retroreflective sheeting may be formed by any suitable methods, including polymer replication, compression molding, or injection molding, by way of example, although other methods of creating the partial retroreflective sheeting, such as embossing and UV casting can be used. In one example, the partial retroreflective sheeting may be made from a curable resin, although the partial retroreflective sheeting may be made of any other suitable materials. Suitable materials include, by way of example only, polymeric epoxies, acrylics, polyester, polyurethane, polycarbonate, or other similar materials. For a UV curable product, the resin is applied to the partial retroreflector tool 10 and then cured into solid form. The resin can be cured using ultraviolet radiation, although other methods of curing the resin such as e-beam and heat curing can be used.

In step 304, the partial retroreflective sheeting, once cured, is then removed from the surface 14 of the partial retroreflector tool 10. The process creates partial retroreflective sheeting with a copy of the partial retroreflective microstructure pattern 14 on a surface thereof to provide partial retroreflection of incident light.

Various coatings may be provided on the surfaces of the partial retroreflective sheeting as described, for example, in PCT Publication No. WO2005/114268, which is hereby incorporated by reference in its entirety.

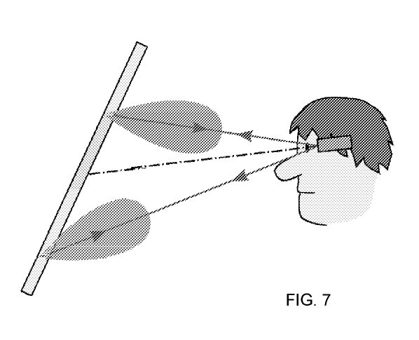

FIG. 7 illustrates an application in which a retroreflective sheeting fabricated using the methods of the present technology may be employed. As illustrated in FIG. 7, a partial retroreflective sheeting may be utilized to provide a heads up display. The retroreflective sheeting provides the ability to have an image retroreflected back to a viewer while simultaneously enabling the viewer to see through the sheeting, such as in a window. Thus, an image can be formed as in a heads-up display using the partial retroreflective sheeting.

Accordingly, with this technology, a partial retroreflector tool is formed by simple machining the surface of a substrate having a microstructure pattern thereon. The process advantageously allows for machining an easily alterable surface, such as a polymer or diamond machinable substrate containing the retroreflective surface. The process further provides flexibility in the amount of retroreflectivity imparted by the resultant part. Further, the tool may be advantageously replicated to form large area, partially retroreflective sheeting that may be utilized, for example, in display applications.

Having thus described the basic concept of the invention, it will be rather apparent to those skilled in the art that the foregoing detailed disclosure is intended to be presented by way of example only, and is not limiting. Various alterations, improvements, and modifications will occur and are intended to those skilled in the art, though not expressly stated herein. These alterations, improvements, and modifications are intended to be suggested hereby, and are within the spirit and scope of the invention. Accordingly, the invention is limited only by the following claims and equivalents thereto.

What is claimed is:

1. A method of forming a partial retroreflector tool, the method comprising:
forming a substrate comprising a retroreflective microstructure pattern on a surface thereof;
machining the surface of the substrate to remove at least a portion of the retroreflective microstructure pattern to form a partial retroreflective microstructure pattern on the surface of the substrate to form the partial retroreflector tool.

2. The method of claim 1, wherein the substrate comprises a polymer substrate.

3. The method of claim 2, wherein forming the polymer substrate comprises compression molding the polymer substrate.

4. The method of claim 1, wherein the substrate is formed based on an electroform comprising the retroreflective microstructure pattern.

5. The method of claim 4, wherein the electroform is an odd generation nickel electroform.

6. The method of claim 1, wherein the retroreflective microstructure pattern comprises triangular, hexagonal, pentagonal, or rectangular projected aperture retroreflectors.

7. The method of claim 1, wherein the retroreflective microstructure pattern comprises multiple types of retroreflectors.

8. The method of claim 1, wherein the retroreflective microstructure pattern comprises individual prisms with variations in tilt, rotation, height, or size.

9. The method of claim 1, wherein the machining comprises machining the surface of the substrate along a direction parallel to the surface.

10. The method of claim 9, wherein the machining is performed using a single point diamond machining tool.

11. The method of claim 1, wherein the machining comprises removing from 5% to 95% of the retroreflective microstructure pattern from the surface of the substrate.

12. The method of claim 1 further comprising:
providing a conductive coating on the surface of the substrate; electroforming the substrate to form a first copy of the retroreflective microstructure pattern; and
electroforming the first copy of the retroreflective microstructure pattern to form a second copy of the retroreflective microstructure pattern.

13. A method for fabricating partially retroreflective sheeting, the method comprising:
obtaining a partial reflector tool having a substrate with a surface with a machined partial retroreflective microstructure pattern;
introducing a polymer material on the machined partial retroreflective microstructure pattern on the surface of the partial reflector tool; and
separating the introduced polymer material from the surface of the partial retroreflector tool to generate the partially retroreflective sheeting.

14. The method of claim 13, wherein the substrate comprises a polymer substrate.

15. The method of claim 13, wherein the substrate comprises a nickel substrate.

16. The method of claim 13, wherein the partial retroreflective sheeting comprises triangular, hexagonal, pentagonal, or rectangular projected aperture retroreflectors.

17. The method of claim 13, wherein the partial retroreflective sheeting comprises multiple types of retroreflectors.

18. The method of claim 13, wherein the partial retroreflective sheeting comprises individual prisms with variations in tilt, rotation, height, or size.

19. The method of claim 13, wherein the generated retroreflective sheeting is at least 1% retroreflective.

20. The method of claim 13, wherein the obtaining further comprises obtaining a plurality of partial reflector tools each having a substrate with a surface with a machined partial retroreflective microstructure pattern, the method further comprising:
parqueting the plurality of partial retroreflector tools;
introducing the polymer material on the machined partial retroreflective microstructure pattern on the surfaces of each of the parqueted partial reflector tools; and
separating the introduced polymer material from the surfaces of each of the parqueted partial reflector tools to generate the partially retroreflective sheeting.

21. The method of claim 13 further comprising providing a coating on the generate partially retroreflective sheeting.

22. The method of claim 13, wherein the retroreflective sheeting comprises polymeric epoxies, acrylics, polyester, polyurethane, or polycarbonate.

23. The method of claim 13, wherein the retroreflective sheeting comprises an even generation of the retroreflective microstructure pattern.
